(19) United States
(12) Patent Application Publication
(10) Pub. No.: US 2015/0206124 A1
(43) Pub. Date: Jul. 23, 2015

(54) SECURE ELECTRONIC ENTITY FOR AUTHORIZING A TRANSACTION

(71) Applicant: OBERTHUR TECHNOLOGIES, Colombes (FR)

(72) Inventors: Yann-Loïc Aubin, Colombes (FR); Christophe Ducros, Colombes (FR); Thierry Despierre, Colombes (FR); David Gauvin, Colombes (FR); Ruben Rico, Colombes (FR)

(21) Appl. No.: 14/414,413

(22) PCT Filed: Jul. 9, 2013
(86) PCT No.: PCT/FR2013/051630

§ 371 Date: Jan. 12, 2015

(30) Foreign Application Priority Data
Jul. 13, 2012 (FR) 1256779

(51) Int. Cl. G06Q 20/32; G06Q 20/38; G06Q 20/40

(52) U.S. Cl. CPC G06Q 20/3226; G06Q 20/40; G06Q 20/3829

(57) ABSTRACT

Various embodiments consistent with the invention relate to a secure electronic entity including a communications interface, the entity being characterized in that it includes means that act, when it is connected via said communications interface to a portable electronic device, including means for connection to a telecommunications network, to enable it: to authenticate a remote transaction verification server in the telecommunications network and to authenticate itself with said remote server; to establish a secure connection, via the telecommunications network, with said remote server; and to receive, via said communications interface, data relating to an intended transaction with a third party device, and to transmit that data, via the secure connection, to the remote server so that it can analyze the data in order to take a decision as to whether to authorize the transaction.

### TECHNICAL FIELD AND PRIOR ART

The invention lies in the field of remote payment, and more precisely of payment at a payment terminal with the help of a portable electronic entity.

It is known to make payment with the help of a smartcard (a bank smartcard) together with a trader's payment terminal, which terminal is connected to a secure communications network over which it communicates with organizations of the EuroPay MasterCard Visa (EMV) payment system.

Communication between the smartcard and the payment terminal may take place with or without contact, in particular by using near field communication (NFC).

The payment terminal contains the application enabling the intended transactions to be verified, given the rules established for the trader and for the payment card. If necessary, it requests authorization from a remote server.

The payment terminal performing these operations is secure, and its holder cannot add new applications thereto.

Thus, a mobile telephone or a graphics tablet cannot be used as a payment terminal, without special development.

Document WO 2008/063990 describes a system for payment at a point of sale that is not necessarily connected to a network. The purchaser uses a mobile telephone to connect to a payment center via the mobile telephone network. The purchaser transmits an identifier of the point of sale to the payment center. Communication between the point of sale and the mobile telephone takes place via short-range communication, or audio communication. The level of security is low.

Document WO 2010/128442 describes a payment terminal incorporated in a secure zone of a memory card, such as a flash memory card, for inserting in a mobile telephone. The card includes a second secure zone that incorporates one or more payment cards issued by one or more banks for the bearer of the telephone. The payment terminal is identified as belonging to a bank or other payment processing body that leases it to the trader. It operates only with an initiator device, which the trader must have available. That solution is not very secure, since it involves a payment terminal being present in the purchaser's telephone.

In order to provide a solution that overcomes the above-mentioned drawbacks, it is desired to provide a secure payment solution that operates with existing compatible mobile telephones and that does not require the trader to acquire new equipment.

### OBJECT AND ADVANTAGES OF THE INVENTION

For this purpose, there is provided a secure electronic entity including a communications interface, the entity being characterized in that it includes means that act, when it is connected via said communications interface to a portable electronic device including means for connection to a telecommunications network, to enable it
to authenticate a remote transaction verification server in the telecommunications network and to authenticate itself with said remote server;
then to establish a secure connection, via the telecommunications network, with said remote server; and
to receive, from the portable electronic device, data relating to an intended transaction with a third party device, and to transmit that data, via the secure connection, to the remote server so that it can analyze the data in order to take a decision as to whether to authorize the transaction.

The invention also provides a transaction verification server including a connection to a telecommunications network, the server being characterized in that it includes means for:
authenticating itself with a secure electronic entity of a remote electronic device in the telecommunications network and authenticating said secure electronic entity;
then establishing a secure connection via said network with said secure electronic entity; and
receiving via the secure connection data concerning an intended application, and processing this data in order to take a decision as to whether to authorize the transaction.

By means of this secure electronic entity and this transaction verification server, a transaction with remote payment can be performed under secure conditions. In particular, the clients of the user of the secure electronic entity can carry out a transaction with the user with a high level of confidence, since they know that their payment data cannot be intercepted by a non-authorized third party. Furthermore, the manager of the verification server can authorize verification and validate intended transactions for which it receives information via the secure connection, since it knows that only the holder of the secure electronic entity could have sent the information.

In a particular embodiment, in order to authenticate the verification server in the telecommunications network, the secure electronic entity sends to said portable electronic device a first exchange authentication element encrypted with a private key of the secure electronic entity, receives from said verification server a second exchange authentication element associated with the verification server, and compares the first and second exchange authentication elements.

In a particular embodiment, in order to authenticate itself with said remote server, the secure electronic entity supplies said portable electronic device with an identification parameter for the payment service, e.g. a subscriber number to the payment service, which parameter is encrypted with a private key of the secure electronic entity.

Likewise, in an embodiment, in order to authenticate the secure electronic entity, the server receives an encrypted signature from the remote electronic device and via said network, and verifies the signature.

In order to authenticate itself with the secure electronic entity, the server may also receive from the remote electronic device an exchange authentication element accompanied by a signature, may verify the signature, and in the event of the verification being positive, may re-send said exchange authentication element to the secure electronic entity.

In advantageous manner, the electronic entity includes means for communicating via said communications interface with an application of a portable electronic device with the help of a secure access mechanism (of the “Access Control” type), thereby enabling the secure electronic entity to send the first exchange authentication element, to supply the subscriber number, or to receive data relating to the intended transaction in secure manner.

Also in advantageous manner, the communications interface may be adapted for communication between the secure electronic entity and a short-range communications interface of the portable electronic device. For example, this communications interface may be of the single wire protocol (SWP) type.

The secure connection may be a connection of the short message service (SMS) type, of the card application toolkit-transport protocol (CAT-TP) type, or of the hypertext transfer protocol (HTTP) type.

Advantageously, the secure electronic entity includes means for taking account of information received from the portable electronic device indicating that a remote server has not been able to authenticate the secure electronic entity.

In one embodiment aspect, the secure electronic entity may further include means for supplying said portable electronic device with an element stored during a preceding use in order to enable the user of the portable electronic device to verify that use is being made of an application of the portable electronic device that the user has already used beforehand.

In another aspect, the secure electronic entity further includes means for verifying the identity of a user of the portable electronic device.

The invention also provides a method of paying a sum of money from an acquirer to a trader, the method comprising the steps of:
using a remote transaction verification server to authenticate the trader and a portable electronic device associated with the trader;
the trader using the portable electronic device associated with the trader in order to input an amount to be paid;
setting up short-range communication between the portable electronic device associated with the trader and a portable electronic device associated with an acquirer, and using the portable electronic device associated with the acquirer to select a payment environment;
using a secure connection to transfer transaction data to the remote server; and
using the remote server to verify the transaction data in order to determine whether the transaction is to be authorized, including in particular steps of the EMV standard for managing terminal risk.

This method presents the advantage of making it possible to use the portable electronic device as a level 2 EMV library with the corresponding approvals, and also of enabling verification operations to be performed remotely in the server.

Authenticating the trader's portable electronic device with the server and setting up the secure connection may advantageously, but not exclusively, be performed with the help of a secure portable electronic entity as described above.

### BRIEF DESCRIPTION OF THE FIGURES

FIG. 1 shows an embodiment of a device of the invention.

FIGS. 2 and 3 show an implementation of a method of the invention.

### DETAILED DESCRIPTION OF EMBODIMENTS

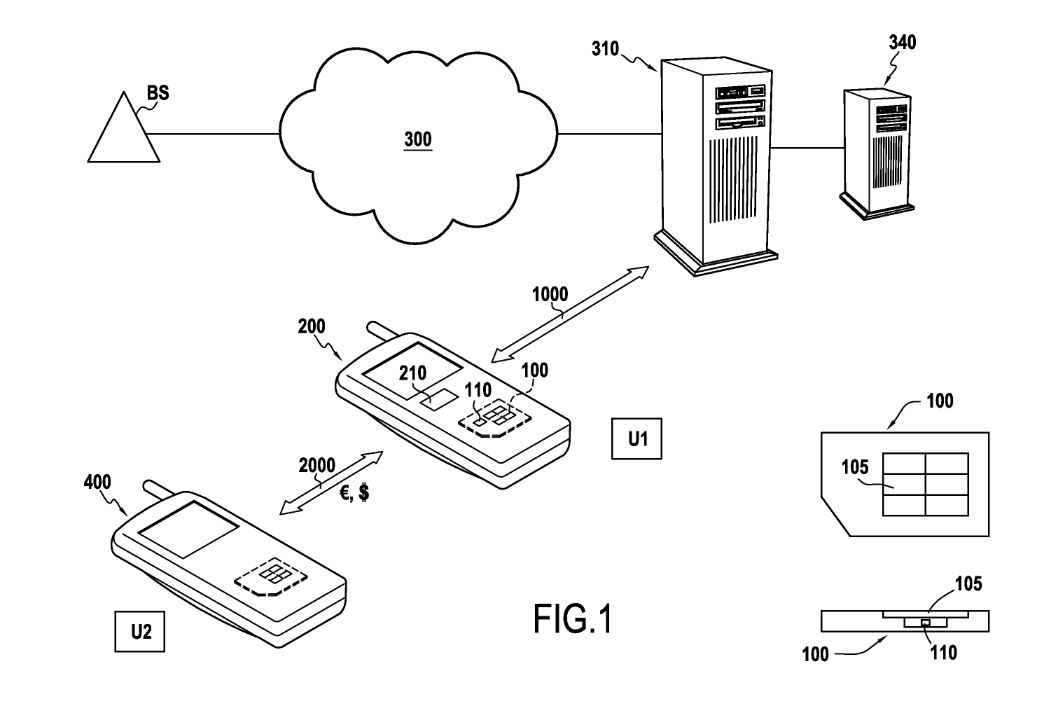

FIG. 1 shows the devices involved in the invention. A trader (creditor) U1 has a portable telephone 200 including a subscriber identity module (SIM) card, also known as a universal integrated circuit card (UICC) 100 that has been handed over to the trader, e.g. by the mobile telephony operator. The SIM card 100 is shown enlarged in the bottom right portion of FIG. 1, in plan view and in section view from the side. The SIM card 100 has a communications interface 105 with contacts enabling it to communicate with the portable telephone 200, e.g. of the SWP or of the ISO 7816 type, and it carries an application 110, commonly referred to as an “applet”, that is configured by the payment acquisition organization and that records in particular a subscription number with the payment acquisition organization. This application 110 enables the transaction to be carried out. Instead of using a SIM card, it is possible to use a micro secure digital (microSD) card or an embedded secure element (eSE).

The mobile telephone 200 is also provided with a vendor payment application 210, commonly referred to as a MIDLET (which means that it complies with the mobile information device profile (MIDP) standard), enabling it to communicate with a user (here the trader U1) in order to perform various functions of a point of sale terminal in association with the application 110 of the SIM card 100 and a remote server (reference 310, and described below).

The trader enters into communication with a purchaser (debtor) U2 who has a mobile telephone 400, or more generally contactless payment means. When the payment means comprise a mobile telephone 400, they are provided with a purchaser payment application (not shown) as previously supplied to the purchaser by the purchaser's bank, or more generally by an issuer of payment means.

The telephone 200 is capable of connecting to a mobile telephony network 300, via a base station BS. The telephones 200 and 400 are capable of communicating with each other directly by short-range wireless communication means, e.g. of the NFC type and complying with the ISO 14443 standard. The communications interface 105, which for example may be of the SWP type, enables the secure electronic entity to communicate with the short-range wireless communication means of NFC type belonging to the terminal.

A server 310 is connected to the mobile telephony network 300. The SIM card 100 and the server 310 are configured to establish a secure connection between them, via a base station of the mobile telephony network. The server 310 is a transaction verification server managed by an organization with which the trader has a subscriber number.

The transaction verification server 310 may enter into communication with a second server 340, which is connected to the server of the issuer of the payment means of the purchaser U2.

The transaction verification server 310 communicates in secure manner with the SIM card 100.

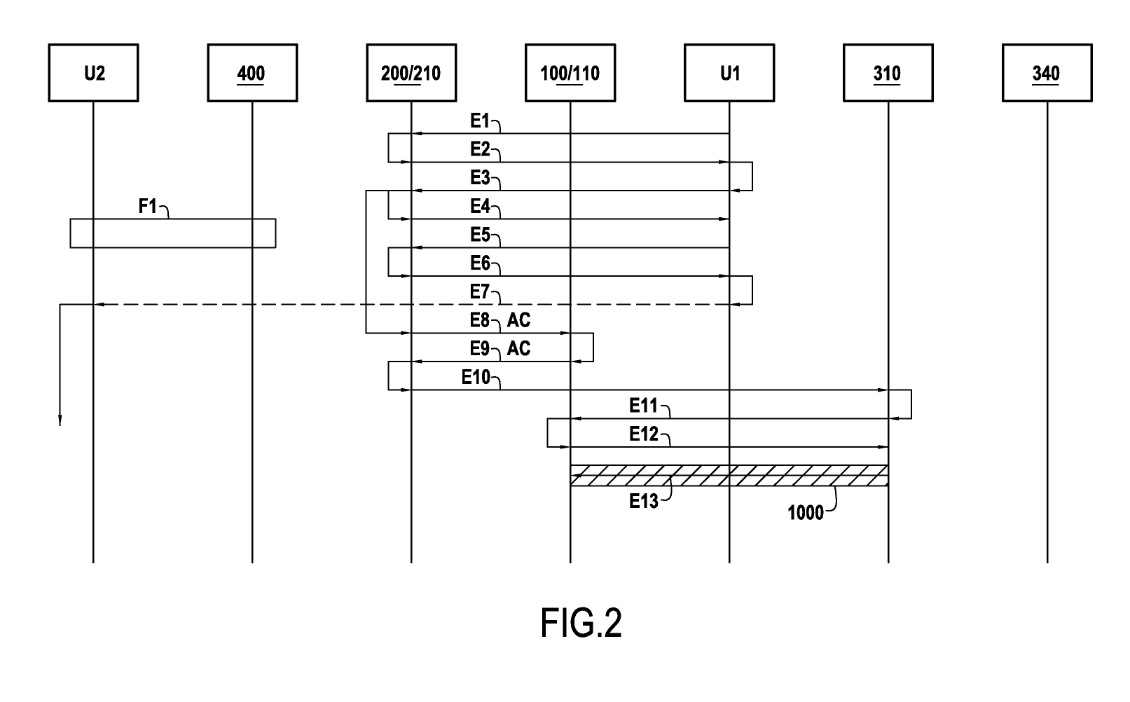

FIG. 2 shows the first portion of a payment method of the invention.

The trader U1 performs a step E1 of activating the payment application 210 of the telephone 200.

The payment application 210 starts and displays the date and time of the most recently accepted transaction, which it reads from the SIM card 100. This display enables the trader U1 to verify that the application in use is an authentic application, and that it has not been replaced by a pirate application (malware, etc.) since the most recent transaction. Some other dynamic information could equally well be used.

The payment application 210 of the telephone 200 then asks the trader U1 to enter a personal identification number (PIN) code via a man-machine interface during a step E2 of requesting the PIN code. During a step E3 the traders U1 then inputs the PIN code. It is possible to use other methods of identifying the trader, such as recognizing biometric data, for example. In a variant, activation of the application 210 may also make use of reading an external tag containing accreditation information of the trader U1.

Thereafter, and during a step E4 and via the man-machine interface, the payment application 210 of the telephone 200 asks the trader U1 to input the amount to be debited. This information is given to the payment application of the telephone 200 during a step E5.

During a step E6, the payment application 210 of the telephone 200 displays an invitation message for the purchaser U2, asking the purchaser to position payment means in the proximity of the short-range communication means of the telephone 200. During a step E7, the trader U1 orally asks the purchaser U2 to place the payment means facing the trader's telephone 200.

During a step E8 in parallel with the steps E4 to E7, the trader's PIN code is transmitted from the application 210 of the telephone 200 to the application 110 of the SIM card 100. The application 110 is a secure application that was input into the SIM card 100 in compliance with the security criteria that apply thereto. It thus possesses a high degree of integrity. By way of example, communication between the payment application 210 of the telephone and the application 110 of the SIM card may take place using the access control mechanism (AC) in order to authenticate the payment application of the telephone with the SIM card (step E8 is associated with the symbol AC in FIG. 2 in order to recall this security).

In turn, the application 110 verifies the trader's PIN code, and then, at the request of the application 210, it generates an exchange authentication element, which has been specially selected for the exchange it is about to undertake with the server 310. In this example, the exchange authentication element is a random number, or any other type of variable data, that is selected after the applet application has verified the PIN code or else at the time the applet application is started.

The application 110 of the SIM card 100 then creates a message comprising both the random number and the trader's specific number (subscriber number), as was input into the SIM card 100 when it was personalized. The application 110 signs and encrypts the message, using an asymmetric cryptographic key that has also been input into the SIM card.

The encrypted message is transmitted by the applet 110 of the SIM card 100 to the payment application 210 of the telephone 200 during a step E9 (made secure using the access control mechanism). The payment application 210 of the telephone is configured to send this message to the server 310 during a step E10, which constitutes a step of the server 310 requesting authentication from the SIM card 100. This transmission takes place using a communications technique that is available in the network 300, e.g. such as sending a short message service (SMS) message, an unstructured additional service data (USSD) message, or a hypertext transfer protocol (HTTP) command. The message is sent to the server 310 using an address of the server, e.g. a telephone number or an Internet address, as stored in the payment application of the telephone 200 or in the SIM card 100.

The server 310 analyzes the content of the received message, decrypting it with the help of the key corresponding to the key previously used by the application 110. It is specified that other cryptographic means could be used, instead of using a pair of asymmetric keys.

The server 310 verifies the signature and the trader's number. Thereafter, if the trader's number matches the signature, it concludes that the sender of the message is indeed the application 110 of the SIM card that was handed over to the trader U1. The terminal 310 sends a return message to the application 110 of the SIM card 100, e.g. in the form of an SMS. During a step E11, the terminal sends a standardized PUSH message constituting a command for requesting the application 110 of the SIM card 100 to open a secure connection in order to communicate therewith. This message contains the random number that was generated by the SIM card 100.

The application 110 of the SIM card 100 receives the PUSH message, decrypts it, and compares the number it contains with the random number that it had itself generated previously. If they are identical, the application concludes that the sender of the PUSH message is a server that is trusted, authentic, and managed by the payment organization.

By way of example, the application 110 of the SIM card then generates, for the server 310, an OpenChannel command, as defined in the ETSI TS 102223 standard, requesting the opening of a secure connection of the SMS, CAT-TP, or HTTP type (where the HTTP variant is defined in Amendment B of the Global Platform standard). This command is transferred during step E12.

By way of example, a secure communications channel 1000 is then set up between the application 110 of the card 100 and the server 310 by using user datagram protocol (UDP) commands for a CAT-TP channel, or transmission control protocol/Internet protocol (TCP/IP) commands for an HTTP channel that are transmitted by the telephone 200 (independently of the payment application) interacting with the SIM card by application protocol data unit (APDU) commands and acknowledgements in order to activate the bearer independent protocol (BIP) system.

Or else, in a variant, SMS messages are exchanged between the server 310 and the application 110 in a manner that is transparent for the telephone 200.

During a step E13, the trading parameters are sent by the server 310 to the application 110 via the secure connection 1000. The trading parameters comprise the bank application identifier (AID) list for the payment terminal, the currencies, the ceilings, and any other data for enabling the application 110 to carry out the payment transaction in independent manner between the trader U1 and the acquirer U2 via the telephones 200 and 400 (including, in the context of an EMV transaction, the following functions: selecting the application, Get Processing Option, Read Record, and Generate AC). The advantage of step E13 is to be able to use the telephone 200 as a level 2 EMV library with the corresponding approvals. Trading parameters are exchanged between the telephone 200 and the SIM card 100 using the security of the Access Control mechanism.

In parallel with the steps E1 to E13, the purchaser U2 performs a step F1 of activating the purchaser payment application of the telephone 400. This activation may comprise inputting a personal code and selecting a payment environment.

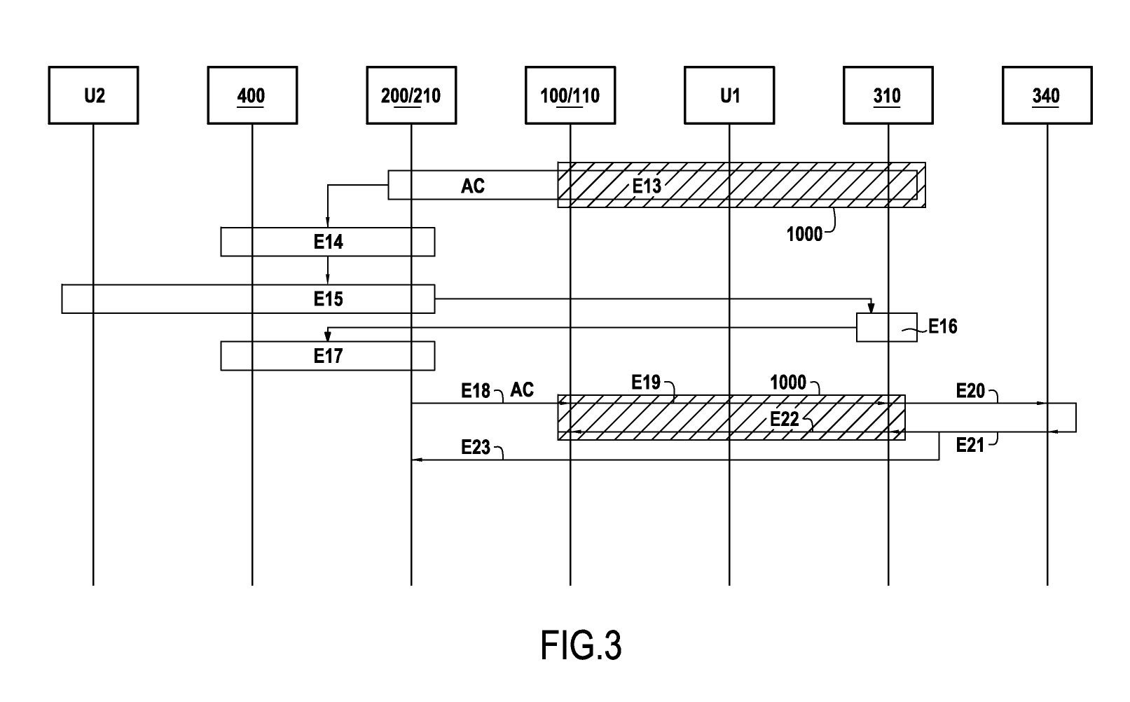

FIG. 3 shows how the method of the invention continues. Step E13 of transmitting the trading parameters to the SIM card and/or to the payment application of the telephone 200 is shown once more.

It is followed by a step E14 of communication between the telephone 200 and the telephone 400 via their NFC interfaces in order to enable the telephone 400 to select the same payment environment as the environment selected by the telephone 200 for the purpose of processing payment options and for authenticating payment application data from the telephone 400 and verifying the number of the payment means (primary account number (PAN)) and the associated expiry date, this information being present in the SIM card of the telephone 400, and being allocated to the purchaser U2 on taking out a subscription with the bank.

A step E15 is then performed of identifying the purchaser U2 by inputting the purchaser's personal code. It is possible to use other methods of identifying the purchaser, in particular biometric recognition. However, for a transaction involving a small amount, it is also possible to omit identifying the purchaser. The personal code is input using the keypad of the telephone 400, and it is verified by communication between the telephones 400 and 200.

A step E16 is then performed of managing (trader) terminal risk. This step is performed entirely on the server 310. It may comprise examining the history of transactions for that day involving the trader U1. The advantage of this step in 16 is to have the verification operations performed remotely in the server 310, for example operations of Cardholder Verification and of Terminal Risk Management, which operations are usually performed in a contactless payment terminal.

Thereafter, a step E17 is performed of generating a transaction cryptogram on the basis of the transaction data (amount, date, place) and of the bank data (bank identifier of the user of the telephone 400). The cryptogram is generated by cooperation between the SIM card of the telephone 400 and the payment application of the telephone 200.

During steps E14 to E17, the application 110 of the SIM card 100 remains inactive.

Thereafter, a step E18 is performed of transmitting transaction data from the payment application 210 of the telephone 200 to the application 110 of the SIM card 100, using the security of the Access Control mechanism. Thereafter, in a step E19, the data is transmitted, possibly after being signed and encrypted, via the secure connection 1000 to the payment authorization server 310. This transfer relates to the amount of the transaction, to the RAN number, to the date, to the place, and to the cryptogram. The server 310 verifies the transaction data and decides whether to authorize or refuse the transaction. The server 310 may also find it necessary to request authorization from the issuer of the payment means, and under such circumstances, it contacts the server 340 during a step E20 in order to obtain such authorization, which is received during a step E21. If the transaction is authorized, a step E22 is performed, during which the server 310 sends its response via the secure connection 1000 to the SIM card 100. A ticket is sent by the server 310, by SMS, to the SIM card 210, during a step E23. The ticket gives the results of the transaction.

The invention is not limited to the implementations described, but covers any variant coming within the ambit of the scope of the claims. In particular, instead of being a mobile telephony network, the network 300 could be an extended network (e.g. the Internet) to which the telephone 200 (or a touch tablet or some other mobile electronic device) has access via a Wi-Fi connection.

1. A secure electronic entity including a communications interface, wherein the entity includes means that act, when connected via said communications interface to a portable electronic device including means for connection to a telecommunications network, to enable the entity:
to authenticate a remote transaction verification server in the telecommunications network and to authenticate the entity with said remote transaction verification server;
to establish a secure connection, via the telecommunications network, with said remote transaction verification server; and
to receive, via said communications interface, data relating to an intended transaction with a third party device, and to transmit the data, via the secure connection, to the remote transaction verification server, which analyzes the data in order to make a decision as to whether to authorize the intended transaction.

2. A secure electronic entity according to claim 1, wherein, in order to authenticate the verification server in the telecommunications network, the secure electronic entity:
sends, via said communications interface, a first exchange authentication element encrypted with a private key of the secure electronic entity,
receives from said remote transaction verification server a second exchange authentication element associated with the verification server, and
compares the first and second exchange authentication elements.

3. A secure electronic entity according to claim 1, wherein, in order to authenticate itself with said remote server, the secure electronic entity:
transmits, via said communications interface, an identification parameter for a payment service, which identification parameter is encrypted with a private key of the secure electronic entity.

4. A secure electronic entity according to claim 1, configured so that the secure connection is a connection of the SMS, CAT-TP, or HTTP type.

5. A secure electronic entity according to claim 1, that includes means for communicating via said communications interface with an application of a portable electronic device with the help of a secure access mechanism.

6. A secure electronic entity according to claim 1, wherein the communications interface is adapted for communication between the secure electronic entity and a short-range communications interface of the portable electronic device.

7. A secure electronic entity according to claim 1, including means for taking account of information received from the portable electronic device indicating that the remote transaction verification server has not been able to authenticate the secure electronic entity.

8. A secure electronic entity according to claim 1, further including means for supplying said portable electronic device with an element stored during a preceding use in order to enable a user of the portable electronic device to verify that use is being made of an application of the portable electronic device that the user has already used beforehand.

9. A secure electronic entity according to claim 1, further including means for verifying the identity of a user of the portable electronic device.

10. A transaction verification server including a connection to a telecommunications network, the transaction verification server comprising means for:
authenticating the transaction verification server with a secure electronic entity of a remote electronic device in the telecommunications network and authenticating said secure electronic entity;
establishing a secure connection via said telecommunications network with said secure electronic entity; and
receiving via the secure connection data concerning an intended transaction; and
processing the data in order to make a decision as to whether to authorize the intended transaction.

11. A server according to claim 10, that, in order to authenticate the secure electronic entity, receives an encrypted signature from the remote electronic device and via said network, and verifies the signature.

12. A server according to claim 10, wherein, in order to authenticate itself with the secure electronic entity, the server:
receives from the remote electronic device an exchange authentication element accompanied by a signature,
verifies the signature, and
in the event of the verification being positive, re-sends said exchange authentication element to the secure electronic entity.

13. A method of paying a sum of money from an acquirer to a trader, the method comprising:
using a secure portable electronic entity and a remote transaction verification server to authenticate a portable electronic device associated with the trader;
the trader using the portable electronic device associated with the trader to input an amount to be paid;
setting up short-range communication between the portable electronic device associated with the trader and a portable electronic device associated with the acquirer, and using the portable electronic device associated with the acquirer to select a payment environment;
using a secure connection set up with the help of the secure portable electronic entity to transfer transaction data to the remote transaction verification server; and
using the remote transaction verification server to verify the transaction data in order to determine whether the transaction is to be authorized, based on the EuroPay MasterCard Visa (EMV) standard for managing terminal risk.
